(19) United States
(12) Patent Application Publication
(10) Pub. No.: US 2024/0077842 A1
(43) Pub. Date: Mar. 7, 2024

(54) Adjustment Support System, Adjustment Support Program, and Adjustment Support Method

(71) Applicant: Hitachi, Ltd., Tokyo (JP)

(72) Inventors: Reiko INOUE, Tokyo (JP); Daiki KAJITA, Tokyo (JP); Takahiro NAKANO, Tokyo (JP)

(21) Appl. No.: 18/204,036

(22) Filed: May 31, 2023

(30) Foreign Application Priority Data
Sep. 6, 2022 (JP) 2022-141430

(51) Int. Cl. G05B 13/04; G06Q 50/04

(52) U.S. Cl. CPC G05B 13/04; G06Q 50/04

(57) ABSTRACT

An adjustment support system includes a controller and a storage, in which the storage holds production line model data related to a model of one or more production facilities in a cyberspace of a production line and actual machine data obtained by actually measuring one or more production facilities disposed in an actual space of the production line, the controller calculates a difference between the production line model data and the actual machine data, upon determination that the difference exists on a basis of a result of calculating the difference, the controller creates one or more adjustment plans each targeting at least one of the model of the one or more production facilities in the cyberspace or the one or more production facilities disposed in the actual space, and the controller outputs the one or more adjustment plans having been created.

### CLAIM OF PRIORITY

The present application claims priority from Japanese patent application JP 2022-141430 filed on Sep. 6, 2022, the content of which is hereby incorporated by reference into this application.

### BACKGROUND OF THE INVENTION

### 1. Field of the Invention

The present invention relates to a technique for supporting adjustment of a production line and a model when the production line is constructed.

### 2. Description of the Related Art

In construction of a production line, a robot and a surrounding environment are modeled on a cyberspace, arrangement design, operation design, performance evaluation, and the like are performed, and then an actual machine is manufactured, introduced, and started on the basis of a design result, and constructed.

At this time, a difference usually occurs between a design value by the model of the cyberspace and an actual measurement value of the actual machine.

JP 6825026 B2 discloses, regarding a difference between a design value by a model of a cyberspace and an actual measurement value of an actual machine, “there are included a virtual model acquisition means for acquiring a virtual model virtually indicating a shape of a peripheral structure of a robot, a movement path acquisition means for acquiring data related to a movement path of the robot, a measured model acquisition means for acquiring a measured model indicating the shape of the peripheral structure of the robot in the actual machine, and a correction means for correcting the data related to the movement path in a case where a movement path shorter than the movement path can be generated on the basis of a difference between the virtual model and the measured model or in a case where interference occurs between the robot and the peripheral structure due to the movement of the robot on the movement path”.

### SUMMARY OF THE INVENTION

In a case where the environment simulated in advance in the cyberspace and the situation of the actual machine are different at the time of starting the actual machine, it is necessary to adjust the results of the arrangement design, the operation design, and the performance evaluation performed in advance in the cyberspace. Therefore, it is necessary to match the model of the cyberspace with the state of the actual machine by at least one of adjusting the actual machine or modifying the model of the cyberspace.

JP 6825026 B2 discloses a method of avoiding interference in the environment of the actual machine by correcting the movement path of the robot with respect to a difference between the design value and the actual measurement value of the actual machine. However, since only the movement path is adjusted in accordance with the actual environment, and adjustment of the actual environment in accordance with the cyberspace is not taken into consideration, there are cases where it is not possible to implement a highly productive operating method and operation obtained in advance by the performance evaluation in the cyberspace.

The present invention has been made in view of the above problems. An object of the present invention is to provide a production line and model adjustment support system allowing a user to select a highly productive adjustment plan by presenting a candidate adjustment plan with at least one of a manufacturing line model of a cyberspace, an actual machine, or the manufacturing line model of the cyberspace and the actual machine as an adjustment target.

In order to solve at least one of the above problems, the present invention is an adjustment support system including a controller and a storage, in which the storage holds production line model data related to a model of one or more production facilities in a cyberspace of a production line and actual machine data obtained by actually measuring one or more production facilities disposed in an actual space of the production line, the controller calculates a difference between the production line model data and the actual machine data, upon determination that the difference exists on the basis of a result of calculating the difference, the controller creates one or more adjustment plans each targeting at least one of the model of the one or more production facilities in the cyberspace or the one or more production facilities disposed in the actual space, and the controller outputs the one or more adjustment plans having been created.

In a production line and model adjustment support system according to one aspect of the present invention, a candidate adjustment plan is presented targeting any of the production line model of the cyberspace, the actual machine, or the production line model of the cyberspace and the actual machine, and the user can select a highly productive adjustment plan.

Note that problems, configurations, and effects other than those described above will be clarified by the following description of embodiments.

### BRIEF DESCRIPTION OF THE DRAWINGS

FIG. 1 is a functional block diagram illustrating an example of a functional configuration of a production line and model adjustment support system according to the present embodiment;

FIG. 2A is an explanatory diagram illustrating an example of production line model data of a cyberspace according to the present embodiment;

FIG. 2B is an explanatory diagram illustrating an example of cyberspace data according to the present embodiment;

FIG. 2C is an explanatory diagram illustrating an example of actual machine sensor data according to the present embodiment;

FIG. 2D is an explanatory diagram illustrating an example of the actual machine sensor data according to the present embodiment;

FIG. 3 is an explanatory diagram illustrating an example of a result display screen of the production line and model adjustment support system according to the present embodiment;

FIG. 4 is a block diagram illustrating an example of a hardware configuration of the production line and model adjustment support system according to the present embodiment;

FIG. 5 is a functional block diagram illustrating another example of the functional configuration of the production line and model adjustment support system according to the present embodiment;

FIG. 6 is an explanatory diagram illustrating an example of an adjustment plan calculated by the production line and model adjustment support system according to the present embodiment;

FIG. 7 is a flowchart illustrating an example of production line and model adjustment plan calculation processing executed in the production line and model adjustment support system according to the present embodiment;

FIG. 8 is an explanatory diagram illustrating an example of past adjustment history data held by the production line and model adjustment support system according to the present embodiment; and

FIG. 9 is a flowchart illustrating an example of evaluation value calculation processing executed in the production line and model adjustment support system according to the present embodiment.

### DESCRIPTION OF THE PREFERRED EMBODIMENTS

Hereinafter, an embodiment of the present invention will be described with reference to the drawings.

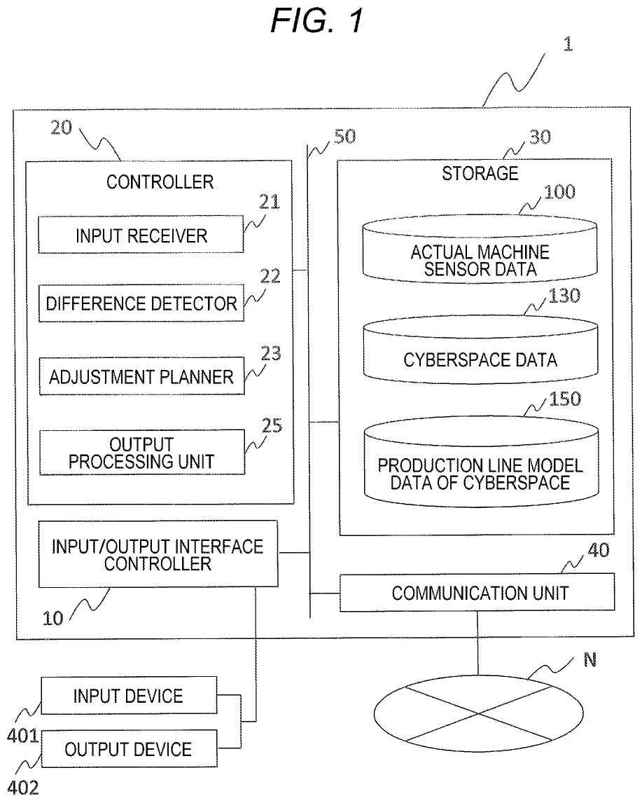

FIG. 1 is a functional block diagram illustrating an example of a functional configuration of a production line and model adjustment support system 1 according to the present embodiment.

The production line and model adjustment support system 1 includes an input/output interface controller 10, a controller 20, a storage 30, a communication unit 40, and a bus 50 that connects the above components. Note that a user (for example, a person in charge of line construction or the like) uses functions of the production line and model adjustment support system 1 via an input device 401 and an output device 402 connected to the input/output interface controller 10.

The input/output interface controller 10 is a functional unit that controls communication between the input device 401 and the output device 402 connected to the production line and model adjustment support system 1.

The controller 20 is a functional unit that controls entire processing of the production line and model adjustment support system 1. The controller 20 includes an input receiver 21, a difference detector 22, an adjustment planner 23, and an output processing unit 25.

The input receiver 21 is a functional unit that receives inputs of various types of information from the input device 401 included in the production line and model adjustment support system 1 or an external device (not shown) connected via the communication unit 40. For example, the input receiver 21 receives input of information regarding an evaluation index and information such as an instruction to execute production line and model adjustment plan calculation processing from the input device 401 such as a keyboard, a mouse, or a touch panel, or from an external device connected via a predetermined communication network N such as the Internet. In addition, the input receiver 21 passes the received information to a corresponding predetermined functional unit.

The difference detector 22 is a functional unit that calculates a difference between an actual measurement value of an actual machine and a design value of a cyberspace.

The adjustment planner 23 is a functional unit that selects any adjustment target of a manufacturing line model of the cyberspace, the actual machine, or the manufacturing line model of the cyberspace and the actual machine, and calculates an adjustment amount.

The output processing unit 25 generates screen information to be displayed on the output device 402 included in the production line and model adjustment support system 1 or the external device. For example, the output processing unit 25 creates input screen information for receiving an input of an evaluation index from the user, and screen information indicating the adjustment target, a calculation result of the adjustment amount, and the like, and displays the input screen information and the screen information on the output device 402.

The storage 30 is a functional unit that memorizes predetermined information. Specifically, the storage 30 includes actual machine sensor data 100, cyberspace data 130, and production line model data 150 of the cyberspace.

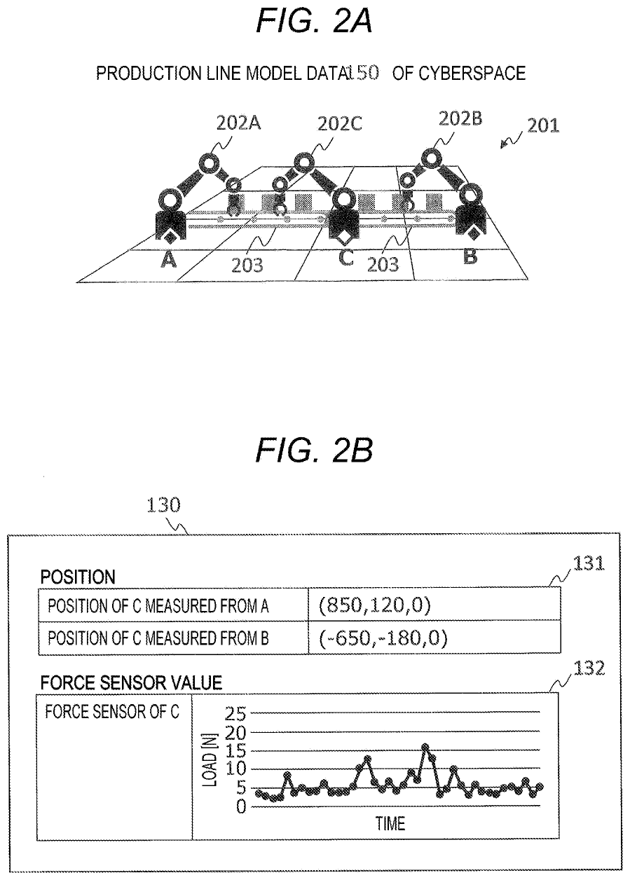

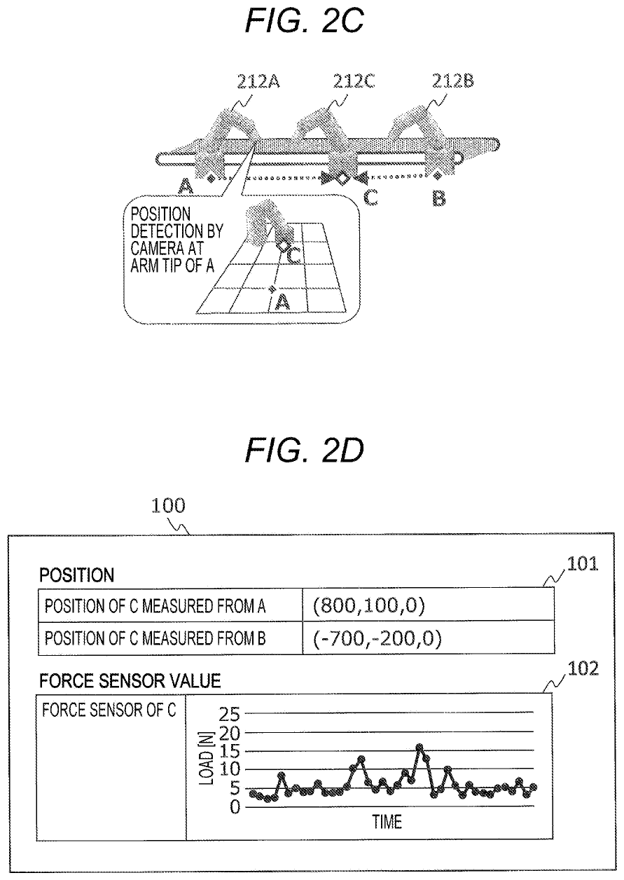

FIG. 2A is an explanatory diagram illustrating an example of the production line model data 150 of the cyberspace according to the present embodiment.

The production line model data 150 of the cyberspace is data related to line representation in the cyberspace. Specifically, the production line model data 150 of the cyberspace is a model in which a conveyor 203 and robots 202A to 202C, which are production facilities, are disposed in a space 201 simulating a production line. This model may be a two-dimensional drawing or may be represented by a three-dimensional model such as three-dimensional CAD.

FIG. 2B is an explanatory diagram illustrating an example of the cyberspace data 130 according to the present embodiment.

The cyberspace data 130 is data obtained on the cyberspace. Specifically, the cyberspace data 130 may include a position 131, a force sensor value 132, and the like.

Here, as an example, a case where robots A and B as actual machines are already installed, and a robot C as a new actual machine is additionally installed will be described. The three robots 202A, 202B, and 202C illustrated in FIG. 2A are models of the robots A, B, and C disposed in the cyberspace 201. In this example, the position 131 includes the position of the robot C measured from the robot A and the position of the robot C measured from the robot B, both of which are data obtained on the cyberspace. Similarly, the force sensor value 132 is obtained by virtually calculating a value that should be acquired if a force sensor is attached to the robot C when each robot is disposed and operated as described above.

FIGS. 2C and 2D are explanatory diagrams each illustrating an example of the actual machine sensor data 100 according to the present embodiment.

The actual machine sensor data 100 is information of an entire line including the robots, a peripheral measurement device, and a plurality of facilities. Specifically, the actual machine sensor data 100 may include a position 101, a force sensor value 102, and the like.

Three robots 212A to 212C illustrated in FIG. 2C indicate the robots A to C which are actual machines installed in an actual space in accordance with the production line model data 150 of the cyberspace illustrated in FIG. 2A. For example, a camera (not shown) is attached to an arm tip of each of the robots A and B of the actual machine, and the position of the robot C acquired from the camera is held as the position 101. In addition, a force sensor (not shown) is attached to the robot C of the actual machine, and a value obtained from the force sensor (that is, an actual measurement value) is held as the force sensor value 102.

Ideally, the position 101 should match the position 131, and the force sensor value 102 should match the force sensor value 132. However, in practice, a difference can occur between the arrangement of the models of the robots in the cyberspace and the arrangement of the robots of the actual machine in the actual space due to an error or the like. Such an error can occur due to various factors such as, for example, insufficient accuracy of installation work of each robot, an error in dimensions of each robot, or unevenness of a floor surface to be installed.

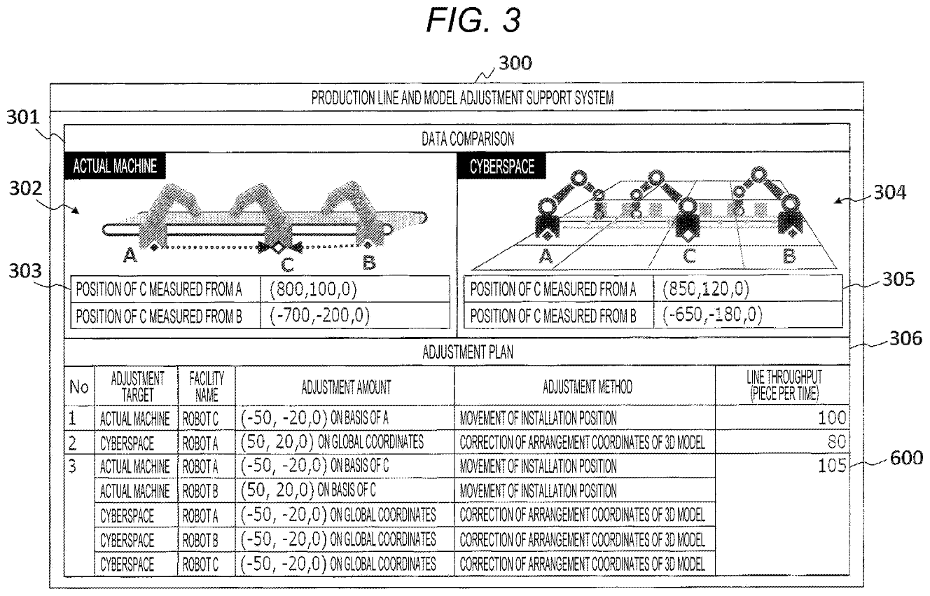

FIG. 3 is an explanatory diagram illustrating an example of a result display screen 300 of the production line and model adjustment support system 1 according to the present embodiment.

The result display screen 300 displays a result of processing of the adjustment planner 23. For example, in a case where the difference detector 22 detects the difference between the actual measurement value of the actual machine and the design value of the cyberspace and the adjustment planner 23 calculates an adjustment plan, or in a case where a display instruction of the result display screen 300 of the production line and model adjustment support system is received from the user via the input receiver 21, the output processing unit 25 generates screen information and displays the screen information on the output device 402.

As illustrated in FIG. 3, the result display screen 300 of the production line and model adjustment support system includes a data comparison region 301 and an adjustment plan display region 306.

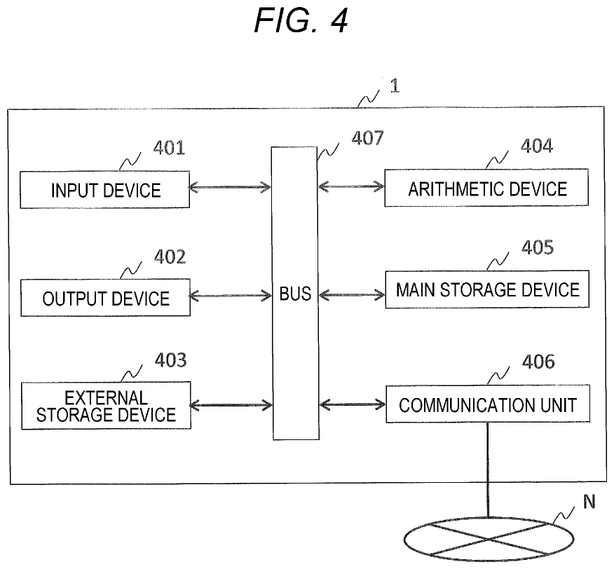

In the data comparison region 301, actual machine data 302 and cyberspace data 304 are displayed. The above data may be similar to those shown in FIGS. 2C and 2A, respectively. Furthermore, as for the actual machine data 302 and the cyberspace data 304, data of a result of detection of a difference by the difference detector 22 is displayed in actual machine difference data 303 and cyberspace difference data 305. The above data may be similar to those shown in FIGS. 2D and 2B, respectively. In FIG. 4, the position 101 and the position 131 are displayed as an example.

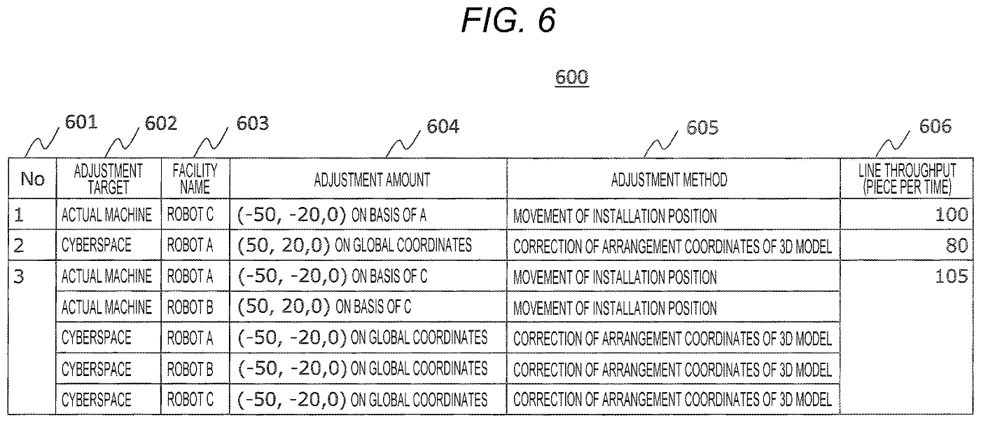

The adjustment plan 600 calculated by the adjustment planner 23 is displayed in the adjustment plan display region 306. Details of the adjustment plan 600 will be described later (see FIG. 6). The user can select any of a plurality of adjustment plans included in the adjustment plan 600 displayed in the adjustment plan display region 306. In addition, the order of the adjustment plans can be rearranged by designating the adjustment target and the other columns. The output processing unit 25 may emphasize the selected adjustment plan with highlight, for example.

FIG. 4 is a block diagram illustrating an example of a hardware configuration of the production line and model adjustment support system 1 according to the present embodiment.

The production line and model adjustment support system 1 can be configured by, for example, a general computer (for example, a personal computer or the like), and implements a characteristic processing function (for example, the controller 20 of the production line and model adjustment support system 1) by software program processing, for example.

As illustrated in the drawing, the production line and model adjustment support system 1 includes the input device 401, the output device 402, an external storage device 403, an arithmetic device 404, a main storage device 405, a communication device 406, and a bus 407 that electrically interconnects the above devices.

The input device 401 is a keyboard, a mouse, a pointing device such as a touch panel, a microphone which is an audio input device, or the like.

The output device 402 is a display, a printer, a speaker which is an audio output device, or the like.

The external storage device 403 is a so-called a hard disk drive or a solid state drive (SSD) capable of memorizing digital information, or a non-volatile storage device such as a flash memory.

The arithmetic device 404 is, for example, a central processing unit (CPU). The main storage device 405 is a memory device such as a random access memory (RAM) and a read only memory (ROM).

The communication device 406 is a device for performing information communication with an external device (not shown), and is a wired communication device that performs wired communication via a network cable or a wireless communication device that performs wireless communication via an antenna.

Note that each functional unit included in the controller 20 is implemented by a program that causes the arithmetic device 404 to perform processing. This program is memorized in the main storage device 405 or the external storage device 403, loaded on the main storage device 405 when the program is executed, and executed by the arithmetic device 404. The storage 30 is implemented by the main storage device 405, the external storage device 403, or a combination thereof. The communication unit 40 is implemented by the communication device 406.

Some or all of the above-described configurations, functions, processing units, processing means, and the like may be implemented by hardware by designing with an integrated circuit, for example. The above configurations and functions may be implemented by software in such a manner that a processor interprets and executes a program for implementing each function. Information such as programs, tables, and files for implementing the functions can be stored in a storage device such as a memory, an HDD, and an SSD, or a recording medium such as an IC card, an SD card, and a DVD.

The hardware configuration of the production line and model adjustment support system 1 has been described above.

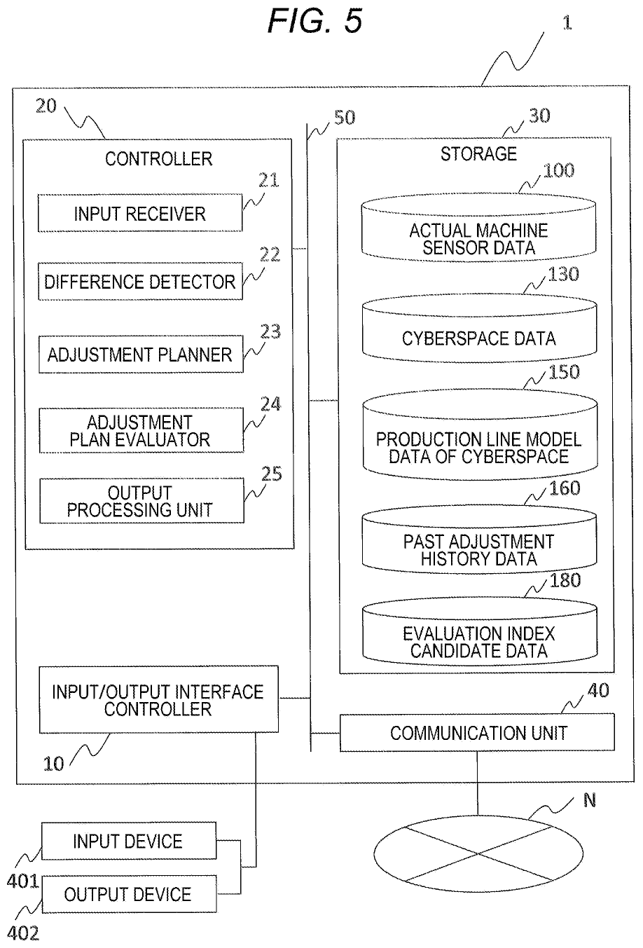

FIG. 5 is a functional block diagram illustrating another example of the functional configuration of the production line and model adjustment support system 1 according to the present embodiment.

The storage 30 includes past adjustment history data 160 and evaluation index candidate data 180. The controller 20 includes an adjustment plan evaluator 24. Other configurations are similar to the configuration of the production line and model adjustment support system 1 illustrated in FIG. 1.

FIG. 6 is an explanatory diagram illustrating an example of the adjustment plan 600 calculated by the production line and model adjustment support system 1 according to the present embodiment.

The adjustment plan 600 includes information of an adjustment plan number 601, an adjustment target 602, a facility name 603 of the adjustment target, an adjustment amount 604, an adjustment method 605, and a line throughput 606 which is an evaluation value of the adjustment plan.

The adjustment plan number 601 is a number for identifying the calculated adjustment plan. The adjustment target 602 indicates whether a target of adjustment is the actual machine or a model of the cyberspace. The facility name 603 indicates a facility of the adjustment target. The adjustment method 605 and the adjustment amount 604 are a method and an amount of adjustment performed in the adjustment plan, respectively, and indicate, for example, movement of the facility and a movement amount of the facility, respectively. The line throughput 606 is a value of the evaluation index calculated for each adjustment plan. FIG. 6 illustrates a case where the line throughput is selected as the evaluation index, but when another evaluation index is selected, the value of the evaluation index is included in the adjustment plan 600.

The adjustment plan 600 illustrated in FIG. 6 includes an example of three adjustment plans calculated in a case where the data illustrated in FIGS. 2A to 2D is obtained. The adjustment target of an adjustment plan whose adjustment plan number 601 is “1” (hereinafter, also referred to as an adjustment plan No. 1) (the same applies to the other adjustment plans) is the robot C (that is, a newly installed robot) of the actual machine. In this plan, the installation position of the actual robot C of the actual machine moves by −50 in an X-axis direction, −20 in a Y-axis direction, and 0 in a Z-axis direction with respect to the robot A. As a result, the position of the robot C of the actual machine becomes the same as the position 131 in the cyberspace illustrated in FIG. 2B, and the difference between the two positions is eliminated.

The adjustment target of an adjustment plan No. 2 is the robot A in the cyberspace. In this plan, arrangement position coordinates of a three-dimensional model of the robot A in the cyberspace are corrected by 50 in the X-axis direction, 20 in the Y-axis direction, and 0 in the Z-axis direction. As a result, the arrangement position of a three-dimensional model of the robot C in the cyberspace becomes the same as the position 101 of the actual machine illustrated in FIG. 2D (that is, the difference is eliminated).

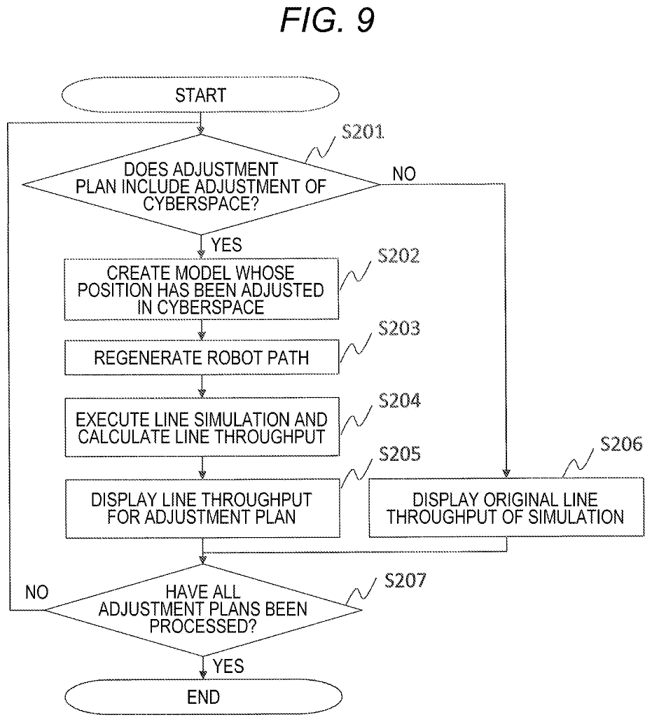

In this case, the positional relationship between the robots A and B of the actual machine and the robot C of the actual machine after adjustment is different from the initial positional relationship in the production line model data 150 of the cyberspace. Therefore, the production line and model adjustment support system 1 need to regenerate a robot path by using the arrangement position coordinates of each robot in the cyberspace after adjustment. Details of this processing will be described later (see FIG. 9).

The adjustment targets of an adjustment plan No. 3 are the robot A of the actual machine, the robot B of the actual machine, the robot A of the cyberspace, the robot B of the cyberspace, and the robot C of the cyberspace. In this plan, the position of the robot A of the actual machine is corrected by −50 in the X-axis direction, −20 in the Y-axis direction, and 0 in the Z-axis direction. The adjustment made in this way will eliminate the difference. In addition, the position of the robot B of the actual machine is corrected by 50 in the X-axis direction, 20 in the Y-axis direction, and 0 in the Z-axis direction. Furthermore, the arrangement position coordinates of the three-dimensional models of the robots A to C in the cyberspace are corrected by −50 in the X-axis direction, −20 in the Y-axis direction, and 0 in the Z-axis direction. In this case, as in the case of the adjustment plan No. 2, a robot path need to be regenerated by using the arrangement position coordinates of each robot in the cyberspace after adjustment.

The above is an example of an adjustment plan in a case where a difference exists between the position of the actual machine and the arrangement of the model on the cyberspace. In a case where a difference exists in the sensor value other than the position, an adjustment plan for bringing the difference close to 0 is created. For example, in a case where a difference exists between the force sensor values 132 and 102, an adjustment plan of control information of a facility such as a robot path for eliminating the difference may be created.

### Description of Operation

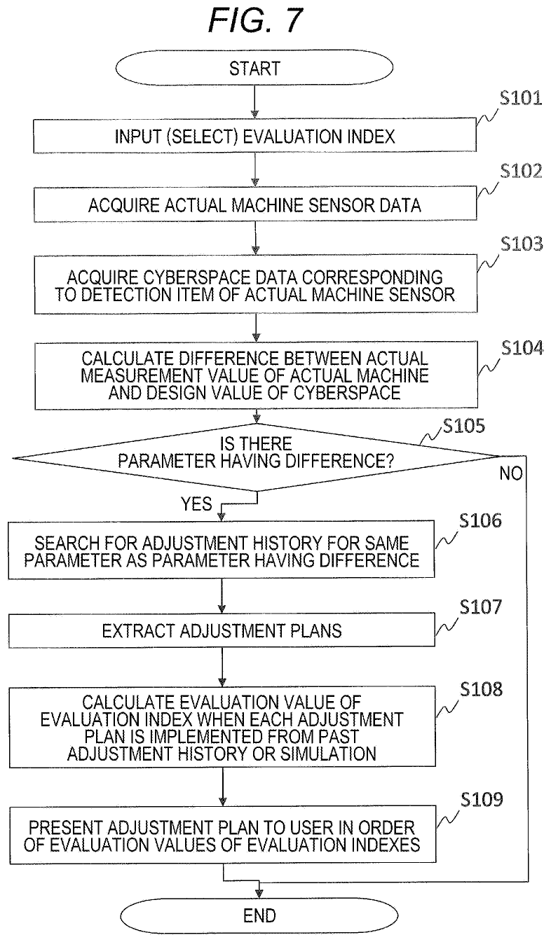

FIG. 7 is a flowchart illustrating an example of the production line and model adjustment plan calculation processing executed in the production line and model adjustment support system 1 according to the present embodiment.

The processing illustrated in FIG. 7 is started, for example, when the input receiver 21 receives an instruction to execute the production line and model adjustment plan calculation processing from the user via the input device 401. For example, after the production line model data 150 of the cyberspace as illustrated in FIG. 2A and the corresponding cyberspace data 130 as illustrated in FIG. 2B are generated, and the robot C of the actual machine is installed in accordance with these data, the user may input an instruction to execute the production line and model adjustment plan calculation processing before actually starting production using the robot C.

When the processing is started, the output device 402 displays the evaluation index candidate data 180 stored in the storage 30. The input receiver 21 receives an input to the evaluation index candidate data 180 (step S101). The evaluation index candidate data 180 is an index for evaluating the adjustment plan, and is, for example, man-hours required for adjustment, cost required for adjustment, a yield of the facility assumed after adjustment, an operation time of the facility after adjustment, and a production line throughput and a lead time of a production line assumed after adjustment. The user selects an evaluation index to be evaluated from the evaluation index candidate data 180 indicated on the output device 402, and inputs the evaluation index to the input receiver 21. Note that the evaluation index may be input from outside.

Next, the difference detector 22 acquires the actual machine sensor data 100 (step S102). The actual machine sensor data 100 is data acquired from a sensor disposed in a line including the robots, a peripheral measurement device, and a plurality of facilities, and includes a variety of types such as a position sensor, a force sensor, a current sensor, a microphone, a weight sensor, and a camera. In the example of FIG. 2D, the position 101 of the robot C and the force sensor value 102 are acquired as the actual machine sensor data 100.

Next, the difference detector 22 acquires cyberspace data corresponding to a detection item of an actual machine sensor (step S103). For example, in a case where the position and the force sensor value are acquired by the actual machine sensor, data corresponding to the position and the force sensor value is acquired in the cyberspace data. In the example of FIG. 2B, the position 131 of the robot C and the force sensor value 132 are acquired.

Then, the difference detector 22 calculates a difference between the actual measurement value of the actual machine and the design value of the cyberspace (step S104). In the examples of FIGS. 2B and 2D, as for the position of the robot C, a difference in (−50, −20, 0) exists between the actual measurement value of the actual machine and the design value of the cyberspace on the basis of the robot A of the actual machine. A parameter having a difference is a position, and the adjustment amount is detected as (−50, −20, 0) on the basis of the robot A of the actual machine or (50, 20, 0) on the basis of the robot A of a cyberspace model. The adjustment target is any of the robot A, the robot B, or the robot C used to calculate the position of the robot C, or a plurality of the robots A, B, and C.

After calculating a difference wp, the difference detector 22 determines whether there is a parameter having a difference (step S105). In a case where there is no parameter having a difference, the processing ends.

If there is a parameter having a difference, the adjustment planner 23 searches for an adjustment history for the same parameter as the parameter having the difference (step S106). At this time, the past adjustment history data 160 which is a history of adjusting the actual machine or the production line model in another case is referred to.

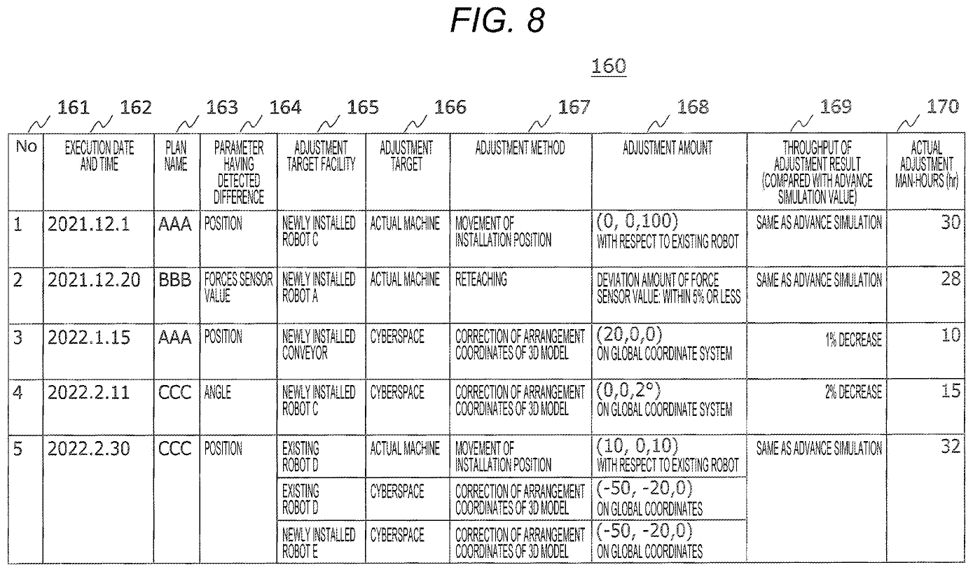

FIG. 8 is an explanatory diagram illustrating an example of the past adjustment history data 160 held by the production line and model adjustment support system 1 according to the present embodiment.

The past adjustment history data 160 includes information of No. 161, execution date and time 162, a case name 163, a parameter 164 having a detected difference, an adjustment target facility 165, an adjustment target 166, an adjustment method 167, an adjustment amount 168, an evaluation value of an adjustment result (here, throughput 169 of the adjustment result), and actual adjustment man-hours 170.

No. 161 is an identification number of data registered in the past adjustment history data 160. The execution date and time 162 indicates a date and time when the past actual adjustment was performed. The case name 163 is a name for specifying a case of adjustment performed in the past. The parameter 164 having the detected difference indicates a parameter in which the difference is detected in the adjustment performed in the past. For example, in a case where a difference in installation position, installation angle, measurement value of a sensor attached to the facility such as a robot or a conveyor, or the like is detected, a value for specifying the difference is held as the parameter 164 having the detected difference.

The adjustment target facility 165 indicates a facility such as a robot or a conveyor which has been a target of adjustment performed in the past. The adjustment target 166 indicates whether the target of adjustment performed in the past is the actual machine or data on the cyberspace. The adjustment method 167 indicates a method of adjustment performed in the past. For example, in a case where movement of the installation position of the facility of the actual machine, reteaching of the facility of the actual machine, correction of the arrangement coordinates or an arrangement angle of the three-dimensional model in the cyberspace, and the like are performed, values indicating the above are held as the adjustment method 167.

The adjustment amount 168 indicates an amount of adjustment performed in the past. As the adjustment amount 168, for example, the movement amount of the installation position of the facility, a correction amount of the installation angle, an allowable amount of a deviation amount of the sensor value at the time of reteaching, and the like are held. The throughput 169 of the adjustment result indicates a value of throughput measured after adjustment performed in the past. For example, as the throughput 169 of the adjustment result, information indicating a difference between a throughput measured after adjustment and a calculation value by an advance simulation (that is, based on the original production line model data 150 of the cyberspace) may be held. Note that, when an index other than the throughput is used as the evaluation index, the value of the index is held.

The actual adjustment man-hours 170 indicates man-hours required for adjustment performed in the past. For example, in a case where adjustment requiring many man-hours such as movement of a large facility is performed, the adjustment is reflected in the actual adjustment man-hours 170.

In the example of FIG. 8, history data of five adjustments performed in the past is held as the past adjustment history data 160. The adjustment history data whose No. 161 is “1” (hereinafter, also referred to as adjustment history data No. 1) (the same applies to the other adjustment history data) is data of adjustment performed on Dec. 1, 2021. This example indicates adjustment performed when a difference was detected in the position parameter, and shows that adjustment was performed to move the installation position of the newly installed robot by 100 in the Z-axis direction with respect to the existing robot, that the throughput after the adjustment was the same as the result of the advance simulation, and that the number of man-hours of the adjustment was 30 hours.

Similarly, each of the adjustment history data Nos. 3 and 5 indicates adjustment performed when a difference was detected in the position parameter. Among the adjustment history data, the adjustment history data No. 3 indicates that the arrangement coordinates of the three-dimensional model of a newly installed conveyor in the cyberspace was adjusted and the man-hour was 10 hours. The adjustment history data No. 5 indicates that the installation position of the actual machine of the existing robot, the arrangement coordinates of the three-dimensional model of the robot in the cyberspace, and the arrangement coordinates of the three-dimensional model of the newly installed robot in the cyberspace were adjusted, and the man-hour was 32 hours.

When the adjustment history is searched, the parameter 164 having the detected difference is referred to, and the parameter that matches the parameter in which the difference is detected in the line to be adjusted is specified. In the example of FIGS. 2B and 2D, since difference exists in the position of the robot C, the adjustment history data in which the value of the parameter 164 having the detected difference is “position” is searched for. As a result, from the past adjustment history data 160 illustrated in FIG. 8, the adjustment history data No. 1 which is a history obtained by adjusting the actual machine, the adjustment history data No. 3 which is a history obtained by adjusting the model of the cyberspace, and the adjustment history data No. 5 which is a history obtained by adjusting both the actual machine and the model of the cyberspace are specified.

Then, the adjustment planner 23 extracts the data of the adjustment target facility 165 and the adjustment method 167 of the adjustment history data Nos. 1, 3, and 5 as an adjustment plan (step S107). This corresponds to the adjustment target 602 and the adjustment method 605 in the adjustment plan 600 of FIG. 6. The facility name 603 of the adjustment target and the adjustment amount 604 are associated with the adjustment target and the adjustment amount extracted in step S104, respectively. As a result, an adjustment plan is created.

Note that, in a case where the storage 30 holds information specifying a facility, model data, or the like to be excluded from the target of adjustment, the adjustment planner 23 creates an adjustment plan not including the specified facility, model data, or the like. For example, in a case where there is a facility whose position is not desirably changed for some reason, the user may input information indicating that the facility is excluded from the adjustment target to the production line and model adjustment support system 1 in advance. The information is held in the storage 30, and in step S107, an adjustment plan that does not include the position of the designated facility as an adjustment target is created.

Furthermore, the adjustment plan evaluator 24 calculates an evaluation value of an evaluation index in a case where each adjustment plan is implemented from the past adjustment history or simulation (step S108). This step will be described later with reference to a flow of FIG. 9. The evaluation value obtained in this step corresponds to the line throughput 606 in the adjustment plan 600 of FIG. 6.

Thereafter, the output processing unit 25 presents the adjustment plan to the user in the order of the evaluation values of the evaluation indexes (step S109).

FIG. 9 is a flowchart illustrating an example of evaluation value calculation processing executed in the production line and model adjustment support system 1 according to the present embodiment.

Specifically, FIG. 9 is an example of the evaluation value calculation processing in step S107 of FIG. 7. Here, an example in which the line throughput after adjustment is selected as the evaluation index will be described. The adjustment plans extracted in step S106 are processed.

First, the adjustment plan evaluator 24 selects one of the plurality of adjustment plans extracted in step S106, and determines whether the adjustment plan includes adjustment of the cyberspace (step S201).

In a case where the adjustment plan is a plan for adjustment of the cyberspace or a plan for adjustment of both the actual machine and the model of the cyberspace (Yes in step S201), the evaluation value obtained in an advance simulation verification is changed by adjusting the model of the cyberspace, and thus, the evaluation is required to be performed again. Therefore, the adjustment plan evaluator 24 first creates a model whose position has been adjusted in the cyberspace (step S202).

Next, the adjustment plan evaluator 24 regenerates the robot path with the adjusted cyberspace model (step S203).

Thereafter, the adjustment plan evaluator 24 executes line simulation in a case where the robot is operated with the generated robot path and calculates a line throughput (step S204).

Note that the robot path is an example of control information in a case where the facility of the adjustment target is a robot. In a case where the facility of the adjustment target is a facility other than a robot, the control information of the facility is regenerated in step S203, and line simulation using the control information regenerated in step S204 is executed.

Next, the output processing unit 25 displays the throughput obtained by the simulation as the line throughput for the adjustment plan of the cyberspace (step S205).

On the other hand, in a case where the selected adjustment plan is the adjustment plan of the actual machine (No in step S201), the evaluation value obtained by the advance simulation verification does not change, and thus the output processing unit 25 displays the original line throughput of the simulation (step S206).

This procedure is executed until all the adjustment plans extracted in step S106 are processed (step S207).

This processing makes it possible to select an adjustment plan by considering how the evaluation index related to production changes in a case where the model of the cyberspace is adjusted.

The adjustment plan 600 of FIG. 6 is calculated by flows of FIGS. 7 and 9. The adjustment plan 600 calculated in this example includes the adjustment plan No. 1 which is a plan for adjusting the actual machine, the adjustment plan No. 2 which is a plan for adjusting the model of the cyberspace, and the adjustment plan No. 3 which is a plan for adjusting both the actual machine and the model of the cyberspace. The user can select the adjustment plan by viewing the line throughput 606 which is the evaluation value. For example, the production line and model adjustment support system 1 may cause the output device 402 to display the result display screen 300, and when the user inputs information for selecting any of the adjustment plans to the input device, the user may select the adjustment plan.

Alternatively, regardless of the user's selection, the production line and model adjustment support system 1 may automatically select an adjustment plan evaluated most highly (for example, an adjustment plan having the maximum throughput) on the basis of the evaluation value.

The adjustment plan 600 indicates the adjustment amount 604 calculated from the difference between the actual measurement value of the actual machine and the design value of the cyberspace in step S104 and the adjustment method 605 extracted from the past adjustment history data 160. For example, in a case where the plan No. 3 for adjusting both the actual machine and the model of the cyberspace is selected, an on-site operator is only required to perform work such as moving and reinstalling the installation positions of the robot A and the robot B by the amount indicated by the adjustment amount 604, and the production line and model adjustment support system 1 is only required to move the arrangement coordinates of the 3D models of the robot A, the robot B, and the robot C by the amount indicated by the adjustment amount 604 to update the model of the cyberspace.

After the adjustment, the difference between the actual measurement value of the actual machine and the design value of the cyberspace is calculated again by using the production line and model adjustment support system, and when a difference exists, the adjustment is only required to be performed again.

The production line and model adjustment support system 1 according to the present embodiment have been described above.

In such a production line and model adjustment support system 1, it is possible to plan a method by which the user can select a highly productive adjustment plan by presenting a candidate adjustment plan with any of the manufacturing line model of the cyberspace, the actual machine, or the manufacturing line model of the cyberspace and the actual machine as an adjustment target.

Note that the system according to the embodiment of the present invention may be configured as follows, for example.

(1) An adjustment support system includes a controller (for example, a controller 20 or an arithmetic device 404 implementing the controller 20), and a storage (for example, a storage 30 or a main storage device 405 or an external storage device 403 implementing the storage 30), in which the storage holds production line model data related to a model of one or more production facilities in a cyberspace of a production line (for example, at least one of a production line model data 150 in a cyberspace or a cyberspace data 130) and actual machine data (for example, actual machine sensor data 100) obtained by actually measuring one or more production facilities disposed in an actual space of the production line, the controller calculates a difference between the production line model data and the actual machine data (for example, step S104), upon determination that the difference exists on the basis of a result of calculating the difference (for example, Yes in step S105), the controller creates one or more adjustment plans (for example, adjustment plans Nos. 1 to 3 of FIG. 6) each targeting at least one of the model of the one or more production facilities in the cyberspace or the one or more production facilities disposed in the actual space (for example, step S107), and the controller outputs the one or more adjustment plans having been created (for example, step S109).

As a result, a candidate adjustment plan is presented targeting any of the production line model of the cyberspace, the actual machine, or the production line model of the cyberspace and the actual machine, and the user can select any of the candidate adjustment plans.

(2) In (1), the controller creates a plurality of the adjustment plans (for example, step S107), the controller calculates, for each of the plurality of adjustment plans having been created, a value of a predetermined evaluation index in a case where adjustment is performed (for example, step S108), and the controller outputs the plurality of adjustment plans and the value of the predetermined evaluation index (for example, step S109).

As a result, the user can select a highly productive adjustment plan from the plurality of presented adjustment plans.

(3) In (2), the evaluation index includes at least one of a required time of adjustment work based on each of the plurality of adjustment plans, a cost of the adjustment work, an operation time of the one or more production facilities after adjustment, a yield of the one or more production facilities after adjustment, or a throughput of the one or more production facilities after adjustment, and in a case where information for designating the predetermined evaluation index is input (for example, step S101), the controller calculates the value of the predetermined evaluation index having been designated.

As a result, the user can select the adjustment plan on the basis of the evaluation index desired by the user.

(4) In (2), the controller selects the adjustment plan evaluated most highly among the plurality of adjustment plans on the basis of the value of the predetermined evaluation index.

As a result, the user can select an adjustment plan evaluated most highly on the basis of a predetermined standard.

(5) In (2), an input device and an output device are further included, the controller causes the output device to display the plurality of adjustment plans and the value of the evaluation index, and in a case where information for indicating any of the plurality of adjustment plans is input to the input device, the controller selects the adjustment plan having been indicated.

As a result, the user can select a desired adjustment plan with reference to the evaluation value of the productivity.

(6) In (2), in a case where the one or more adjustment plans include the adjustment plan targeting the model of the one or more production facilities in the cyberspace (for example, the adjustment plan No. 2 or 3 of FIG. 6), the adjustment plan includes information for adjusting data of the model of the one or more production facilities in the cyberspace so as to reduce the difference, and the controller creates control information of the one or more production facilities in the cyberspace by using the data of the model of the one or more production facilities, the data being adjusted on a basis of the adjustment plan (for example, step S203), and the controller calculates the value of the predetermined evaluation index by executing a simulation based on the data having been adjusted and the control information having been created (for example, step S204).

As a result, it is possible to calculate the value of the evaluation index in a case where the data of the cyberspace is adjusted.

(7) In (1), the storage further holds adjustment history data (for example, past adjustment history data 160) indicating a difference detected in the past and a history of adjustment performed in the past corresponding to the difference, and the controller creates the one or more adjustment plans on a basis of a result of collation between the difference having been calculated and the difference detected in the past (for example, steps S106 and S107).

As a result, it is possible to create an adjustment plan expected to be effective.

(8) In (7), the controller specifies, from the history of adjustment performed in the past, a history of adjustment performed for a parameter including the difference having been calculated (for example, in a case where a different of a position parameter is calculated in step S104, specifies the adjustment history data Nos. 1, 3 and 5 of FIG. 8 which adjustment history data when the difference of position is detected), and creates the one or more adjustment plans on a basis of the history of adjustment having been specified.

As a result, it is possible to create an adjustment plan expected to be effective in accordance with the parameter in which the difference is detected.

(9) In (1), the storage further holds information indicating that at least one of the model of the one or more production facilities in the cyberspace or the one or more production facilities disposed in the actual space is excluded from an adjustment target, and the controller creates one or more adjustment plans targeting the model of the one or more production facilities in the cyberspace or the one or more production facilities disposed in the actual space, not excluded from the adjustment target.

As a result, it is possible to create an appropriate adjustment plan in accordance with the actual situation of the production line.

(10) In (9), in a case where information designating, as a subject of exclusion from the adjustment target, the model of the one or more production facilities in the cyberspace or the one or more production facilities disposed in the actual space is input, the controller stores information indicating that the subject is excluded from the adjustment target in the storage.

As a result, it is possible to create an appropriate adjustment plan in accordance with the actual situation of the production line.

(11) In (1), in a case where one of the one or more adjustment plans is an adjustment plan targeting the model of the one or more production facilities in the cyberspace and the adjustment plan is selected, the controller creates the model of the one or more production facilities in the cyberspace, the model being adjusted on a basis of the adjustment plan having been selected.

As a result, the selected adjustment plan can be promptly reflected in the system of the production line.

(12) In (1), in a case where one of the one or more adjustment plans is an adjustment plan targeting the model of the one or more production facilities in the cyberspace (for example, the adjustment plan No. 2 of FIG. 6), the adjustment plan includes information for adjusting data of the model of the one or more production facilities in the cyberspace so as to reduce the difference, and in a case where one of the one or more adjustment plans is an adjustment plan targeting the one or more production facilities disposed in the actual space (for example, the adjustment plan No. 1 of FIG. 6), the adjustment plan includes information for adjusting arrangement of the one or more production facilities in the actual space so as to reduce the difference, and in a case where one of the one or more adjustment plans is an adjustment plan targeting both the model of the one or more production facilities in the cyberspace and the one or more production facilities disposed in the actual space (for example, the adjustment plan No. 3 of FIG. 6), the adjustment plan includes the data of the model of the one or more production facilities in the cyberspace and the information for adjusting the arrangement of the one or more production facilities in the actual space so as to reduce the difference.

As a result, it is possible to create an appropriate adjustment plan in accordance with the adjustment target.

Note that the present invention is not limited to the above embodiment. The above embodiment can be variously modified within the scope of the technical idea of the present invention.

For example, in the above embodiment, the line throughput is selected as the evaluation index, but a plurality of evaluation indexes such as the line throughput and the adjustment man-hours may be selected, and the user may select the adjustment plan on the basis of the plurality of evaluation indexes on the result display screen.

In addition, in a case where an adjustment plan of the cyberspace model is selected for the calculated adjustment plan, the cyberspace model may be automatically edited and adjusted.

Note that the example described above has been described in detail to facilitate understanding of the description of the invention, and the invention is not required to include all the configurations described above. A part of the configuration of one example can be replaced with a configuration of another example, and the configuration of one example can be added to a configuration of another example. It is possible to add, delete, and replace another configuration for a part of the configuration of each example.

Some or all of the above-described configurations, functions, processing units, processing means, and the like may be implemented by hardware by designing with an integrated circuit, for example. The above configurations and functions may be implemented by software in such a manner that a processor interprets and executes a program for implementing each function. Information such as a program, a table, and a file for implementing each function can be stored in a storage device such as a non-volatile semiconductor memory, an HDD, and an SSD, or a computer-readable non-transitory data storage medium such as an IC card, an SD card, and a DVD.

In the above description, control lines and information lines that are considered to be necessary for explanation are shown, and not all control lines and information lines in a product are necessarily shown. In practice, it may be considered that almost all the configurations are interconnected.

What is claimed is:

1. An adjustment support system comprising:
a controller; and
a storage,
wherein the storage holds production line model data related to a model of one or more production facilities in a cyberspace of a production line and actual machine data obtained by actually measuring one or more production facilities disposed in an actual space of the production line,
the controller calculates a difference between the production line model data and the actual machine data,
upon determination that the difference exists on a basis of a result of calculating the difference, the controller creates one or more adjustment plans each targeting at least one of the model of the one or more production facilities in the cyberspace or the one or more production facilities disposed in the actual space, and
the controller outputs the one or more adjustment plans having been created.

2. The adjustment support system according to claim 1, wherein
the controller creates a plurality of the adjustment plans,
the controller calculates, for each of the plurality of adjustment plans having been created, a value of a predetermined evaluation index in a case where adjustment is performed, and
the controller outputs the plurality of adjustment plans and the value of the predetermined evaluation index.

3. The adjustment support system according to claim 2, wherein
the evaluation index includes at least one of a required time of adjustment work based on each of the plurality of adjustment plans, a cost of the adjustment work, an operation time of the one or more production facilities after adjustment, a yield of the one or more production facilities after adjustment, or a throughput of the one or more production facilities after adjustment, and
in a case where information for designating the predetermined evaluation index is input, the controller calculates the value of the predetermined evaluation index having been designated.

4. The adjustment support system according to claim 2, wherein
the controller selects the adjustment plan evaluated most highly among the plurality of adjustment plans on a basis of the value of the predetermined evaluation index.

5. The adjustment support system according to claim 2, further comprising:
an input device; and
an output device,
wherein the controller causes the output device to display the plurality of adjustment plans and the value of the evaluation index, and
in a case where information for indicating any of the plurality of adjustment plans is input to the input device, the controller selects the adjustment plan having been indicated.

6. The adjustment support system according to claim 2, wherein
in a case where the one or more adjustment plans include the adjustment plan targeting the model of the one or more production facilities in the cyberspace, the adjustment plan includes information for adjusting data of the model of the one or more production facilities in the cyberspace so as to reduce the difference, and
the controller creates control information of the one or more production facilities in the cyberspace by using the data of the model of the one or more production facilities, the data being adjusted on a basis of the adjustment plan, and
the controller calculates the value of the predetermined evaluation index by executing a simulation based on the data having been adjusted and the control information having been created.

7. The adjustment support system according to claim 1, wherein
the storage further holds adjustment history data indicating a difference detected in a past and a history of adjustment performed in the past corresponding to the difference, and
the controller creates the one or more adjustment plans on a basis of a result of collation between the difference having been calculated and the difference detected in the past.

8. The adjustment support system according to claim 7, wherein the controller specifies, from the history of adjustment performed in the past, a history of adjustment performed for a parameter including the difference having been calculated, and creates the one or more adjustment plans on a basis of the history of adjustment having been specified.

9. The adjustment support system according to claim 1, wherein
the storage further holds information indicating that at least one of the model of the one or more production facilities in the cyberspace or the one or more production facilities disposed in the actual space is excluded from an adjustment target, and
the controller creates one or more adjustment plans targeting the model of the one or more production facilities in the cyberspace or the one or more production facilities disposed in the actual space, not excluded from the adjustment target.

10. The adjustment support system according to claim 9, wherein in a case where information designating, as a subject of exclusion from the adjustment target, the model of the one or more production facilities in the cyberspace or the one or more production facilities disposed in the actual space is input, the controller stores information indicating that the subject is excluded from the adjustment target in the storage.

11. The adjustment support system according to claim 1, wherein in a case where one of the one or more adjustment plans is the adjustment plan targeting the model of the one or more production facilities in the cyberspace and the adjustment plan is selected, the controller creates the model of the one or more production facilities in the cyberspace, the model being adjusted on a basis of the adjustment plan having been selected.

12. The adjustment support system according to claim 1, wherein
in a case where one of the one or more adjustment plans is the adjustment plan targeting the model of the one or more production facilities in the cyberspace, the adjustment plan includes information for adjusting data of the model of the one or more production facilities in the cyberspace so as to reduce the difference, and
in a case where one of the one or more adjustment plans is the adjustment plan targeting the one or more production facilities disposed in the actual space, the adjustment plan includes information for adjusting arrangement of the one or more production facilities in the actual space so as to reduce the difference, and
in a case where one of the one or more adjustment plans is the adjustment plan targeting both the model of the one or more production facilities in the cyberspace and the one or more production facilities disposed in the actual space, the adjustment plan includes the data of the model of the one or more production facilities in the cyberspace and the information for adjusting the arrangement of the one or more production facilities in the actual space so as to reduce the difference.

13. An adjustment support program executed by an adjustment support system, wherein
the adjustment support system includes a controller and a storage,
the storage holds production line model data related to a model of one or more production facilities in a cyberspace of a production line and actual machine data obtained by actually measuring one or more production facilities disposed in an actual space of the production line, and
the adjustment support program causes the controller to execute
a procedure of calculating a difference between the production line model data and the actual machine data,
upon determination that the difference exists on a basis of a result of calculating the difference, a procedure of creating one or more adjustment plans each targeting at least one of the model of the one or more production facilities in the cyberspace or the one or more production facilities disposed in the actual space, and
a procedure of outputting the one or more adjustment plans having been created.

14. An adjustment support method executed by an adjustment support system, wherein
the adjustment support system includes a controller and a storage,
the storage holds production line model data related to a model of one or more production facilities in a cyberspace of a production line and actual machine data obtained by actually measuring one or more production facilities disposed in an actual space of the production line, and
the adjustment support method includes
a procedure of calculating a difference between the production line model data and the actual machine data by the controller,
upon determination that the difference exists on a basis of a result of calculating the difference, a procedure of creating, by the controller, one or more adjustment plans each targeting at least one of the model of the one or more production facilities in the cyberspace or the one or more production facilities disposed in the actual space, and
a procedure of outputting, by the controller, the one or more adjustment plans having been created.
